(19) United States
(12) Patent Application Publication
(10) Pub. No.: US 2005/0247776 A1
(43) Pub. Date: Nov. 10, 2005

(54) Authenticating optical-card reader

(75) Inventors: W. Jack Harper, Evergreen, CO (US); Kevin Wilson, Denver, CO (US); Glenn Junik, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 11/122,784

(22) Filed: May 4, 2005

Related U.S. Application Data
(63) Continuation-in-part of application No. 10/921,596, filed on Aug. 18, 2004.
(60) Provisional application No. 60/568,407, filed on May 4, 2004.

(51) Int. Cl. G06K 5/00; G06K 7/10; G06K 7/14

(52) U.S. Cl. 235/380; 235/454; 235/382

(57) ABSTRACT

Methods and devices are provided for reading optical cards. A housing has a slot for slidably receiving an optical card. The optical card has physical tracks with an arrangement of physical pits to define on optically encoded biometric. A light detector is fixed in position relative to the housing. An optical train is also fixed in position relative to the housing and is configured to provide optical paths between the light detector and the optical card as the optical card is slid along the slot. A biometric sensor is provided. A processor is coupled with the light detector and with the biometric sensor. The processor has programming instructions to compare a biometric measured by the biometric sensor with the optically encoded biometric read from the optical card with the light detector.

### CROSS-REFERENCES TO RELATED APPLICATIONS

This application is a nonprovisional of, and claims the benefit of the filing date of U.S. Prov. Pat. Appl. No. 60/568,407, entitled “AUTHENTICATING OPTICAL-CARD READER,” filed May 4, 2004 by W. Jack Harper, the entire disclosure of which is incorporated herein by reference for all purposes.

This application is also a continuation-in-part of U.S. patent application Ser. No. 10/921,596, entitled “SYSTEMS AND METHODS FOR READING OPTICAL-CARD DATA,” filed Aug. 18, 2004 by Kevin Wilson, the entire disclosure of which is incorporated herein by reference for all purposes.

### BACKGROUND OF THE INVENTION

This application relates generally to optical cards. More specifically, this application relates to an optical-card reader.

The development of optical cards has been relatively recent. They are cards that are typically made to be about the size of a standard credit card and which store digitized information in an optical storage area. The information written to the optical storage area is generally written according to a standards protocol that includes, among other things, physical layout restrictions for the optical card. The information encoded in the optical storage area often includes information that identifies a holder of the card, and as such optical cards are expected to become widely used as identification instruments. Indeed, a number of government authorities have already begun to issue optical cards for use as national identity cards, as immigration cards, and the like.

In order to read the information from the optical storage area of an optical card, it has typically been necessary to use an optical reading device specially manufacture to accommodate the physical layout of information on the optical card. Such systems generally operate by mounting lasers on complex optical heads that automatically servo down parallel tracks to overcome problems of card skewing, mechanical intolerances, and track-to-track drift. The complex arrangement of mechanical parts makes such readers vulnerable to mechanical failure, and thereby reduces their reliability.

There is accordingly a need in the art for improved optical-card readers.

### BRIEF SUMMARY OF THE INVENTION

Embodiments of the invention thus provide methods and devices for reading optical cards. In a first set of embodiments, a read-only optical device is provided. A housing has a slot for slidably receiving an optical card. The optical card has a plurality of physical tracks with an arrangement of physical pits to define on optically encoded biometric. A light detector is fixed in position relative to the housing. An optical train is also fixed in position relative to the housing and is configured to provide optical paths between the light detector and the optical card as the optical card is slid along the slot. A biometric sensor is provided. A processor is coupled with the light detector and with the biometric sensor. The processor has programming instructions to compare a biometric measured by the biometric sensor with the optically encoded biometric read from the optical card with the light detector.

In some embodiments, the read-only optical device further comprises a security actuator coupled with the processor, with the security actuator being activated to permit access to a controlled area or function if the measured biometric substantially matches the optically encoded biometric read from the optical card. The biometric sensor may comprise a fingerprint sensor or other type of biometric sensor in different embodiments. A first light interruption switch may be disposed to identify the presence of the optical card within the slot, and in some instance a second light interruption switch may also be provided.

The optical card may comprise a plurality of logical tracks disposed transversely across the optical card, with each such logical track comprising a plurality of the physical tracks. The optical train comprises a fanout element to provide distinct optical paths between the light detector and transverse portions of the optical card corresponding to different ones of the logical tracks. In one specific embodiment, the optical train further comprises a collimation element, a partially reflective mirror, and a focusing element. The collimation element is disposed to collimate light incident on the fanout element. The partially reflective mirror is disposed to reflect light emanating from the fanout element to the focusing element and to permit light reflected from the optical card to propagate to the light detector. The focusing element is disposed to focus light reflected from the partially reflective mirror onto the optical card. The fanout element itself may comprise first and second partially reflective mirrors. A beam incident on the first partially reflective mirror is partially reflected to provide a first beam and is partially transmitted to provide an intermediate beam incident on the second partially reflective mirror. The intermediate beam is partially reflected from the second partially reflective mirror to provide a second beam and is partially transmitted by the second partially reflective mirror to provide a third beam.

The light detector may sometimes comprise a multielement array sensor. The light detector may alternatively comprise a compact-disc laser head adapted to read data from a compact disc having data encoded as a series of binary pits formed within a plurality of compact-disc tracks separated by an average compact-disc track pitch; the compact-disc laser head is oriented relative to a length of the slot to accommodate a difference between an average optical-card track pitch separating the plurality of physical tracks and the average compact-disc track pitch.

In a second set of embodiments, a method is provided for controlling access to a restricted area or function. A presence of an optical card being moved manually by a human being is detected. The optical card has a plurality of physical tracks with an arrangement of physical pits to define an optically encoded token. A fixed region through which a surface of the optical card passes as the optical card is moved manually by the human being is illuminated. Light reflected from the optical card as the optical card is moved manually by the human being is propagated to a fixed light detector to read the optically encoded token. A reference token is received from the human being. The token received from the human being is compared with the optically encoded token read from the optical card.

In one embodiment, the comparison that is performed is a biometric comparison. The optically encoded token comprises an optically encoded biometric and receiving the reference token from the human being comprises measuring a biometric from the human being. The reference token received from the human being is compared with the optically encoded token read from the optical card by comparing the biometric measured from the human being with the optically encoded biometric read from the card.

In some instances, a security actuator is actuated to permit access to the restricted area or function if the biometric measured from the human being substantially matches the optically encoded biometric read from the optical card. Measuring the biometric from the human being may comprise measuring a fingerprint from the human being. The optical card may comprise a plurality of logical tracks disposed transversely across the optical card, with each logical track comprising a plurality of the physical tracks. Light reflected from the optical card as the optical card is moved manually by the human being is propagated to the fixed light detector by propagating light reflected from different ones of the logical tracks along distinct optical paths to the fixed light detector.

In a third set of embodiments, an optical card is provided comprising a substrate having a plurality of physical pits formed within a plurality of physical tracks organized as a series of substantially parallel rows within the substrate. The physical pits define a pattern of blobs within a plurality of logical tracks. Each such logical track spans a plurality of the physical tracks. The pattern of blobs is an encoded arrangement of data.

In some instances, the encoded arrangement of data may comprise an encoded biometric. In one embodiment, the plurality of logical tracks consists of three tracks. One of the three tracks may comprise a timing track. The timing track may be a center one of the three tracks and comprise a logical blob sequence of alternating binary states. In some cases, an optically transparent protective layer may overlay the substrate. The optically transparent protective layer may have a thickness at least five times a thickness of the substrate.

In a fourth set of embodiments, a method is provided for reading an optical card having a plurality of physical pits formed within a plurality of physical tracks organized as a series of substantially parallel rows within the substrate. Each of a plurality of logical tracks is illuminated, with each such logical track spanning a plurality of the physical tracks. Light reflected from the plurality of logical tracks is received to identify a pattern of blobs within the plurality of logical tracks. Each such blob comprises a two-dimensional array of physical pits. The pattern of blobs is decoded to identify an encoded arrangement of data.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components

FIGS. 1A-1C provide schematic illustrations of different forms of optical cards that may be used in embodiments of the invention;

FIG. 2 provides an example of an optical data region that may be read from an optical card in an embodiment of the invention;

FIG. 3 is a schematic illustration of an authentication system that uses an authenticating optical-card reader in accordance with an embodiment of the invention;

FIGS. 4A and 4B provide exemplary illustrations of physical structures that may embody an authenticating optical-card reader of the invention;

FIG. 5 provides a schematic illustration of an internal structure for an authenticating optical-card reader in one embodiment;

FIG. 6 provides a schematic illustration of an optical arrangement that may be used as part of the internal structure for an authenticating optical-card reader in an embodiment;

FIG. 7 provides a schematic illustration of beamsplitter arrangements that may be used with the embodiment of FIG. 6;

FIG. 8 provides a schematic illustration of an internal structure for an authenticating optical-card reader in another embodiment;

FIGS. 9A and 9B provide an illustration of a structure for a compact-disc laser head used in the embodiment of FIG. 8;

FIG. 10 is a flow diagram illustrating a method for determining an orientation of a compact-disc laser head for use in reading optical-card data;

FIG. 11 is a flow diagram illustrating a method for authenticating an individual in accordance with embodiments of the invention;

FIG. 12 shows a CCD image of a portion of an optical data region, showing how tracks may be read using an optical card reader in embodiments of the invention; and

FIG. 13 provides an illustration of the effect of contamination on the ability to read optical-card data.

### DETAILED DESCRIPTION OF THE INVENTION

Embodiments of the invention provide an optical-card reader that may be used to authenticate individuals. In some embodiments, the optical-card reader advantageously has few or no moving part, and thus has high reliability. The optical-card reader may also be provided as a compact self-contained unit, which makes it convenient for use in applications as a sentry device. In particular, the optical-card reader may be used to control access to a restricted area by being positioned near a door to the restricted area, unlocking the door only when it has authenticated a person authorized to have access to the area. In some instances, the optical-card reader may be interfaced with a local- or wide-area network to report accesses to a central remote server, although in many embodiments, it acts entirely as a local device to control access without other communications. Certain simplifications in the design of the optical-card reader arise from configurations in which it is provided as a read-only device without write capability, although in other embodiments such write capability may additionally be provided.

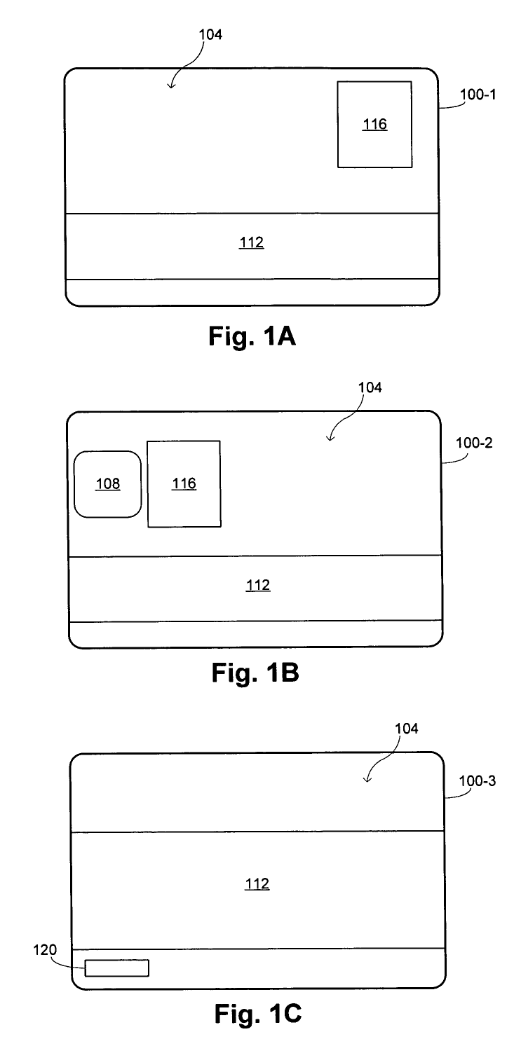

These embodiments may function well with a variety of optical-card designs, some of which are illustrated in FIGS. 1A-1C. Such optical cards may be of the specific type described in U.S. Pat. No. 5,979,772, entitled “OPTICAL CARD” by Jiro Takei et al., the entire disclosure of which is incorporated herein by reference for all purposes, but more generally include any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 1000 times the amount of information as a typical smart card. Unlike smart cards, optical cards are also impervious to electromagnetic fields, including static electricity, and they are not damaged by normal bending and flexing.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser etches a small pit, about 2 μm in diameter, in the material; the pit can be sensed by a low-power laser during a read cycle. The presence or absence of the pit defines a binary state that is used to encode data. In some embodiments, the data can be encoded in a linear x-y format described in detail in the ISO/IEC 11693 and 11694 standards, the entire contents of which are incorporated herein by reference for all purposes.

FIG. 1A provides a diagram that illustrates a structure for an optical card in one embodiment. The card 100-1 includes a cardholder photograph 116, an optical storage area 112, and a printed area 104 on one side of the card. The other side of the card could include other features, such as a bar code(s) or other optically recognizable code, a signature block, a magnetic stripe, counterfeiting safeguards, and the like. The printed area 104 could include any type of information, such as information identifying the cardholder so that, in combination with the photograph 116, it acts as a useful aid in authenticating a cardholder's identity. The printed area 104 could also include information identifying the issuer of the card, and the like. The optical storage area 112 holds digitized information, and may comprise a plurality of individual sections that may be designated individually by an addressing system.

Another embodiment of an optical banking card 100-2 is illustrated in FIG. 1B. This embodiment adds electronics 108 to the optical card 100-2 to provide smart-card capabilities. The electronics 108 may be interfaced with contacts on the surface of the card 100-2. The electronics could include a microprocessor, nonvolatile memory, volatile memory, a cryptographic processor, a random-number generator, and/or any other electronic circuits. Unlike the optical storage area 112, information stored in the electronics 108 is not discernible without destroying the card 100-2. Electronic security measures could be used to protect reading information stored in the electronics 108.

A further embodiment of an optical banking card 100-3 is shown in FIG. 1C. To illustrate that different embodiments may accommodate different sizes of optical storage areas, this embodiment uses a larger optical storage area 112 than the embodiments of FIG. 1A or 1B. In addition, a radio-frequency identification (“RFID”) tag 120 that can be read by proximity readers may be included.

Data on the optical card may be described in terms of “physical pits,” which are the actual pits burned into the card medium by a laser when data are written to the card. A “physical track” is a single row of physical pits going across the card. A “blob” is used herein to refer to an H×K array of physical pits and a “logical track” refers to a series of blobs across the card to form a pattern on the card that visually resembles a bar code. Certain embodiments of the invention forgo mechanisms for active tracking and focusing to limit the movable mechanical structure of the optical-card reader. Accordingly, these embodiments do not resolve and read individual physical pits, but instead rely on reading groups of pits that make up the logical tracks. The data may be arranged into a plurality of logical tracks, being arranged into three logical tracks in one embodiment. Merely by way of example, the logical tracks may comprise blobs having as size of (H=8)×(K=150).

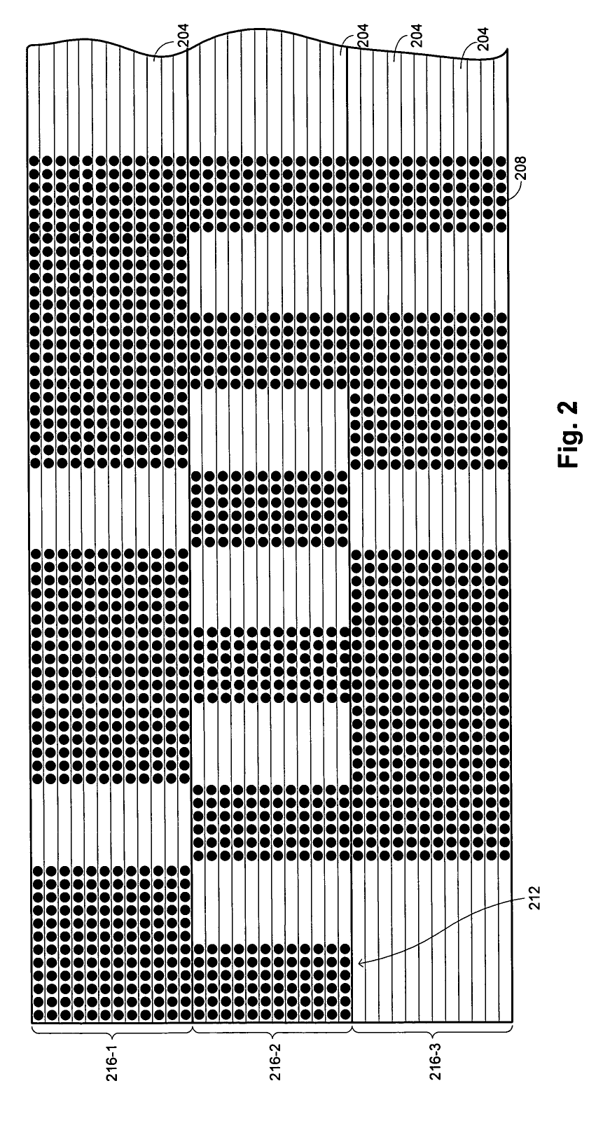

FIG. 2 provides a depiction of an embodiment of the optical storage area 112 on an optical card 100 using such a structure. The physical pits are denoted by reference number 208, the physical tracks are denoted by reference number 204, the blobs are denoted by reference number 212, and the logical tracks are denoted by reference number 216. This example shows an embodiment in which the number of logical tracks 216 is three, although the number of physical tracks 204 comprised per logical track 216 and the number of physical pits 208 comprised per blob 212 has been significantly reduced for purposes of illustration. In this illustration, each logical track 216 comprises twelve physical tracks 204 and each blob comprises an (H=12)×(K=6) physical pits 208. The biometric information is encoded on the scale of the blobs 212 across the logical tracks 216.

In one specific embodiment, a biometric may be stored with about 576 bytes, including an error-check code and self-clocking mechanism, and may be distributed across three logical tracks with 192 bytes per logical track. In another specific embodiment, one of the logical tracks is used as a timing track that has a series of logical blobs encoded with a sequence to provide timing information for the other logical tracks. For instance, FIG. 2 illustrates an embodiment in which the middle logical track 216-2 is used as the timing track with a logical blob sequence 101010101010 . . . . Use of the middle logical track 216-2 as the timing track reduces intertrack jitter by having it as close as possible to each of the data logical tracks 216-1 and 216-3.

Other configurations of the optical data may be used in other embodiments, some of which are described in U.S. Prov. Pat. Appl. No. 60/568,407, which has been incorporated by reference. For example, biometric data could be interleaved on physical tracks with timing tracks. Alternatively, the biometric parameter could be stored in a known location of the optical storage area 112 without the use of tracking tracks. In some instances, a unique photomask could be included on the optical card 100 or embedded in the optical storage area 112. An example of such an embedded photomask is described in U.S. patent application Ser. No. 10/832,930, entitled “EMBEDDED HOLOGRAMS ON OPTICAL CARDS,” filed Apr. 26, 2004 by Kevin Wilson, the entire disclosure of which is incorporated herein by reference for all purposes. It may be confirmed that an optical card has the correct photomask as part of a validation of the optical card, such as when a U.S. resident-alien card includes a special photomask embedded in the optical storage area 112 that may be checked. This may be performed with or without tracking tracks and in some embodiments, the photomask could be located and used as a tracking reference in lieu of or in addition to tracking tracks. More generally, embodiments of the invention may accommodate the use of any reference reticle on the optical card 100 that is at a known location relative to the optical storage area 112.

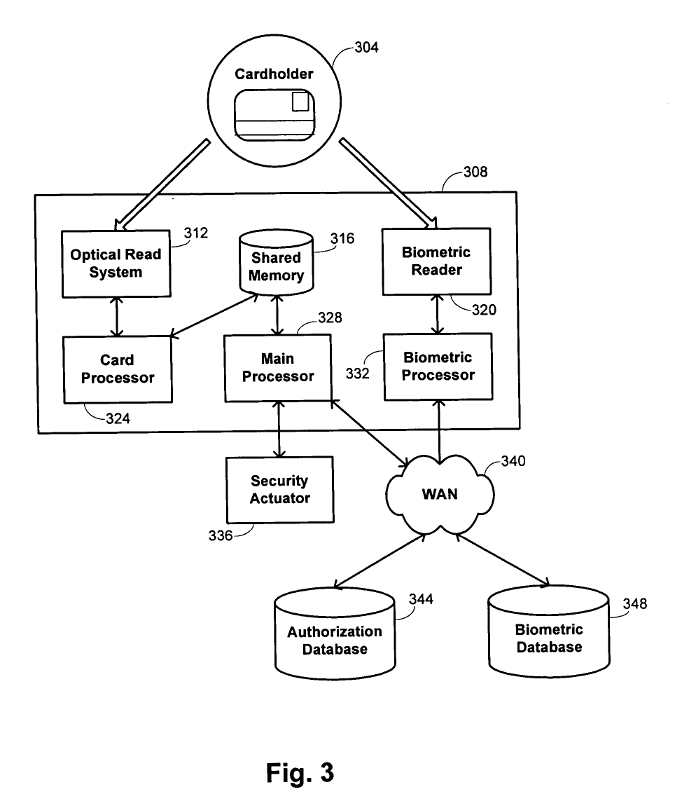

An optical card 100 having the biometric information encoded as described above may be used to perform a controlled function, such as gaining access to a restricted area by presenting the optical card to an optical-card reader configured to extract the biometric information from the card and compare it with directly measured biometric information. One example of a structure of such an authentication system is illustrated in FIG. 3. A cardholder 304 who carries an optical card 100 and wishes to perform the controlled function presents the optical card 100 to an optical-card reader 308. While the following discussion sometimes makes reference to a specific application in which the controlled function comprises gaining access to a secured area, it should be understood that the system may more generally be used to perform any application requiring authentication, including financial applications, health-care applications, computer access, identity authentication, etc.

The optical-card reader 308 is typically mounted proximate to the secured area. In response to the cardholder 304 inserting the card into, or swiping the card through, the optical-card reader 308, an optical read system 248 reads the biometric parameter from the optical storage area 112. The cardholder 304 also presents a body portion for measurement by a biometric scanner 320 incorporated into the optical-card reader 308. A direct biometric measurement is made of the body portion, such as by reading a fingerprint, a voiceprint, a retinal image, a facial geometry, a hand geometry, or the like. The cardholder 304 is authenticated as a result of a comparison between the measured biometric and the biometric parameter read from the optical card 100. Some authentication systems may require a plurality of biometric parameters to be compared and/or require comparison of an additional security code, all of which are checked against parameters stored on the optical card 100. As part of the authentication process, some embodiments of the optical-card reader 308 check an authorization database 344 over a wired or wireless wide-area network 340 to determine whether a particular cardholder is authorized to enter the secured area after authentication of his identity. Some other embodiments integrate the authorization database 344 into the optical card reader 308. It is expected that most commonly, however, the authorization information itself will be stored on the optical card 100.

Once a cardholder 304 is authenticated and authorization is confirmed, a security actuator 336 is activated, such as by releasing a door lock to open a passageway into a secured area. In one embodiment, the optical card reader 308 supports the Wiegand Protocol such as is described in the SIA Access Control Standard Protocol for the 26-bit Wiegand TM Reader Interface, the entire disclosure of which is incorporated herein by reference for all purposes. The Wiegand Protocol is a wiring protocol used in industrial applications and is a commonly used interface used in the access-control and security industries. Other embodiments could directly actuate the mechanism that unlocks the door from the secured area.

The biometric parameter may also be stored in some embodiments in a biometric database 348 accessible over the wide-area network 340. Where the biometric parameter cannot be read from the optical card 100, the biometric database 348 could be accessed for this information. Also, the biometric database 348 could be used to verify that the optical card 100 has not been improperly modified. Some embodiments do not have wide-area network access at all and rely solely upon information read from the optical card 100 and/or with an integral authorization database.

In the embodiment illustrated in FIG. 3, the optical card reader 308 includes three processors 324, 328, and 332, an optical read system 312, a shared memory 316, and a biometric reader 320. In a specific embodiment, each processor 324, 328, and 332 includes a parallel high-speed 16-bit architecture running in parallel, e.g., Rabbit. A card processor 324 interfaces with the optical read system 312 to control reading of the optical card 100. The stored biometric parameter on the card 100 is written to the shared memory 316 after being read from the optical card 100. A biometric processor 332 interfaces with the biometric reader 320 to gather a measured biometric parameter from the cardholder 304. The measured biometric parameter is also written to the shared memory 316. A main processor 328 compares the measured and stored biometric parameters to determine whether they are consistent within a certain predefined tolerance level. With a match determined in this way, authorization is checked by reading the optical card 100 for a record of authorization or by accessing the authorization database 344. If the main processor 328 determines that the cardholder 304 has been authenticated and is authorized for access, a command is sent to the security actuator 336. If there is no biometric match, the card might be rescanned, with access being permanently denied after a certain number of failed attempts.

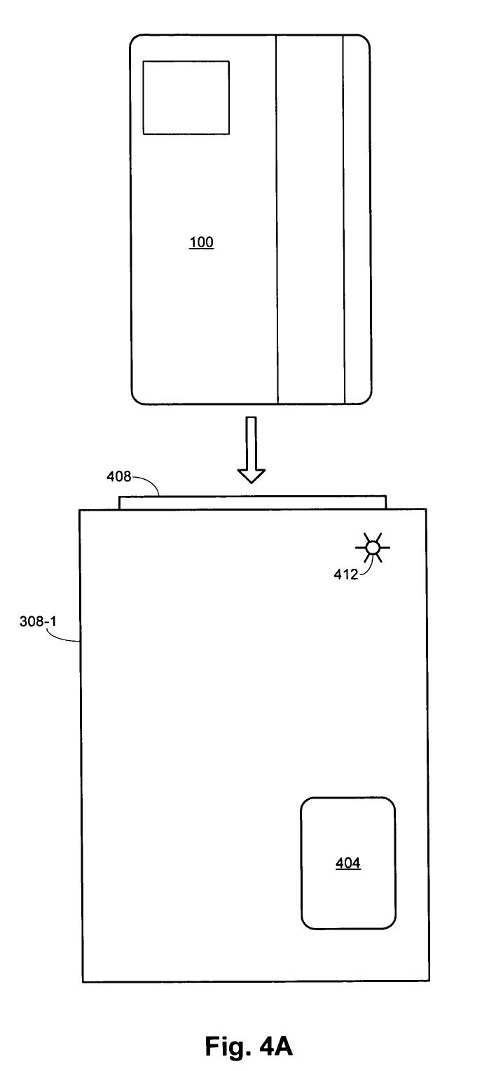

There are a number of different physical structures that may be used to implement the optical card reader 308 and to have it mate with an optical card 100. An illustration of one such embodiment is provided in FIG. 4A, in which the optical card 100 is inserted into the optical card reader 308 through a card slot 408. The biometric reader is embodied in a fingerprint scanner 404 on an exterior surface of the optical card reader 308, although other types of biometric readers may be incorporated in different embodiments. A status light 412 is provided, and different configurations may be implemented to indicate a status of the optical card reader 308. For instance, in one embodiment, the status light might normally be on green, blinking three times in succession to indicate a successful authentication and authorization. Alternatively, a three-state light could be used with a normal off state changing to green when the reader is ready to receive a card, flashing green when the security actuator 336 is actuated, or changing to red when there is a failure to authenticate and/or authorize the cardholder 304 for entry. The status light 412 could be augmented or replaced by a display or screen in some embodiments. When the optical card reader 308 has a wireless interface, an antenna may be visible from outside its enclosure.

An alternative physical structure is illustrated in FIG. 4B, which is similar but provides a slot 416 through which the optical card 100 may be swiped. Other components of the device, including the fingerprint scanner 404 and the status light 412 may function similarly to those components in the embodiment of FIG. 4A.

The optical card reader 308 may be mounted on a wall, free to be placed on a desk, integral to a cellular telephone or PDA, or provided in any of a variety of other configurations. The desktop version could be free to move about or be mounted to the desk. In one application, the optical card reader 308 is screwed down to a flat table for access by an immigration agent to authenticate a holder of an optical immigration card, for example.

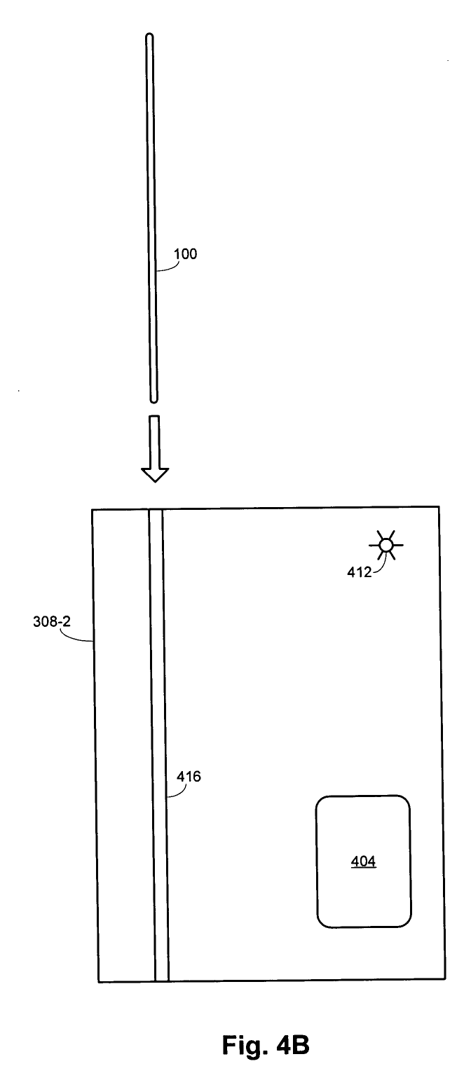

A number of different configurations may also be used internally to read the optical storage area 112. One embodiment is illustrated in FIG. 5, which shows a side sectional view of the optical card reader 308 to illustrate the optical card-reading mechanism. The card slot is denoted generally by reference number 504 and may correspond to the internal slot 408 of the embodiment of FIG. 4A or to the swipe slot 416 of the embodiment of FIG. 4B. A roller 532 may either propel the card 100 or provide uniform resistance to regulate the speed of the card through the slot 504. The roller 504 could be made of rubber or otherwise be resilient enough to secure the card 100. A first light interruption switch 524-1 senses when the card 100 is inserted into the slot 504. The electronics and roller 532, if powered, are activated when the first interruption switch 524 senses an inserted card 100. The optical card reader 308 could be in a low-power mode until the first interruption switch 524 senses an incident card 100.

In embodiments where the card 100 is inserted, a second light interruption switch 524-2 may sense when the card 100 has been fully inserted, after which the card 100 can be removed by the cardholder 304 or ejected by the roller 532. In embodiments where the card 100 is swiped, the second interruption switch 524-2 may be omitted or may be used to sense when the swiping has been completed. In embodiments where the card is inserted and then removed from the optical card reader 308, information may be read a second time from the card while it is being removed, enabling a comparison to be made with either of the two readings, thereby reducing the number of incorrect denials.

A multielement sensor 508 is used to read the optical storage area 112 of the card 100 as it passes by at a speed regulated by the roller 532. The speed of the roller 532 can be controlled such that movement of the card 100 is synchronized with the multielement sensor 508. An optical matching and illuminating system provides light that is directed to the surface of the card 100 by on optical folder 516 and focused with an objective 520. The particular optical routing achieved with such an arrangement is merely exemplary and other optical arrangement to provide paths between the surface of the card 100 and the multielement sensor 508. In one embodiment, the multielement sensor 508 includes a 1×1024 linear CCD array, but other embodiments could use any sensor with multiple elements, such as a linear CMOS sensor array or a two-dimensional CCD or CMOS sensor. In the illustrated embodiment, the multielement sensor 508 is sized such that the blobs an the logical tracks may be read by a sufficient number of elements to generate a representation of the portion of the optical storage area that is read.

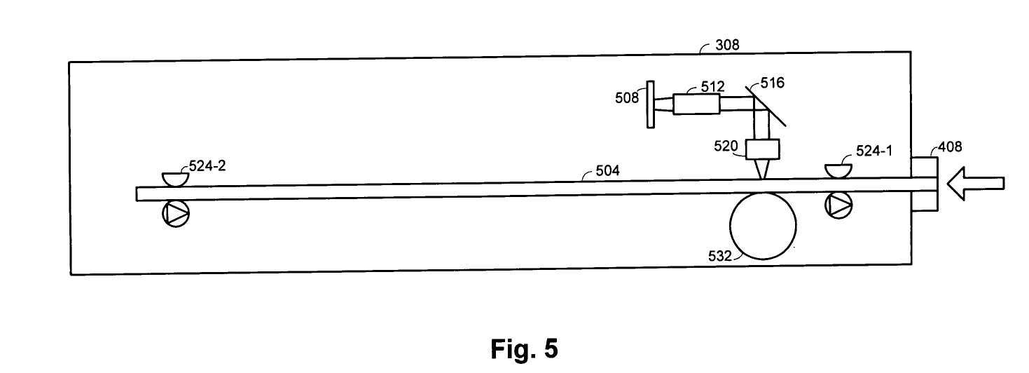

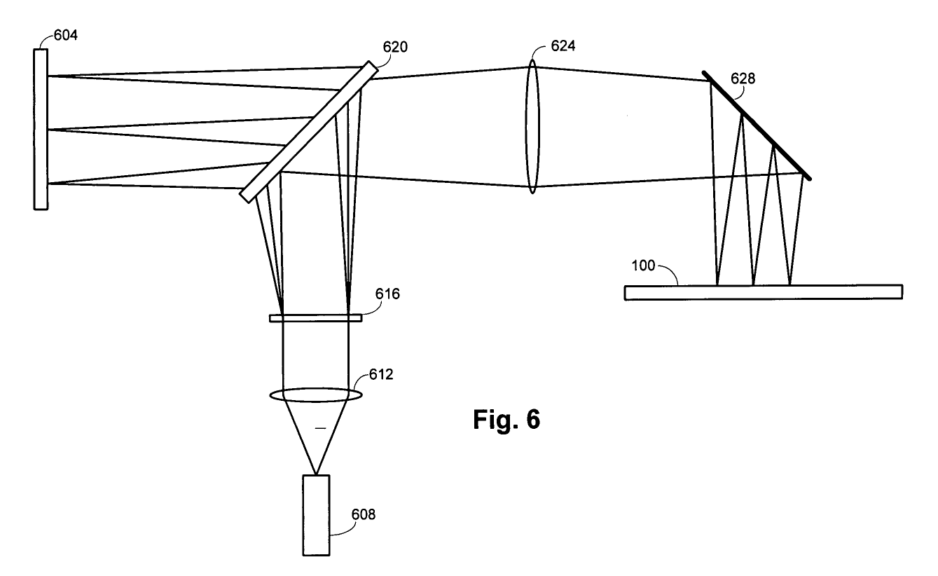

FIG. 6 provides a more detailed illustration of an optical arrangement that may be used in an embodiment to read a plurality of logical tracks having the structure described in connection with FIG. 2. In this embodiment, an illumination source 608 provides a beam of light, such as a substantially coherent beam of light as might be provided by a laser source, that is incident on a fanout element 616 after being collimated by a collimation element 612, such as a lens. The fanout element 616 splits the incident beam into a plurality of beams and exemplary structures for the fanout element are shown in FIGS. 7A and 7B. For instance, as shown in FIG. 7A, the fanout element 616-1 may comprise a specialized spherical lens that splits an incident beam 700 into three output beams 704. Alternatively, as shown in FIG. 7B, the fanout element 616-2 may comprise a plurality of mirrors or other reflective elements arranged to perform the splitting. In FIG. 7B, each of reflective elements 708 is a fully reflective element, while each of reflective elements 712 is a partially reflective element. When a beam 700 is incident on the arrangement, a portion of the beam is reflected by the first partially reflective element 712-1 and then reflected by the first fully reflective element 708-1 to generate the first output beam 704-1. The second output beam 704-2 is generated by transmitting a portion of the beam transmitted through the first partially reflective element 712-1 through the second partially reflective element 712-2. Light that is transmitted by the first partially reflective element 712-1 and reflected by the second partially reflective element 712-2 is reflected by the second fully reflective element 708-2 to produce the third transmitted beam 704-3.

Referring again to FIG. 6, the separated beams are incident on a partially reflective element 620 that forms part of an optical arrangement to direct the beams to the surface of the card 100. The beams are reflected from the partially reflective element 620 and focused by an objective 624, perhaps also being reflected by a folding element 628 depending on the size and orientation of the assembly. Light from each of the three tracks is transmitted back through the arrangement to the multielement sensor 604 where it is interpreted to identify the presence or absence of blobs on the respective logical tracks.

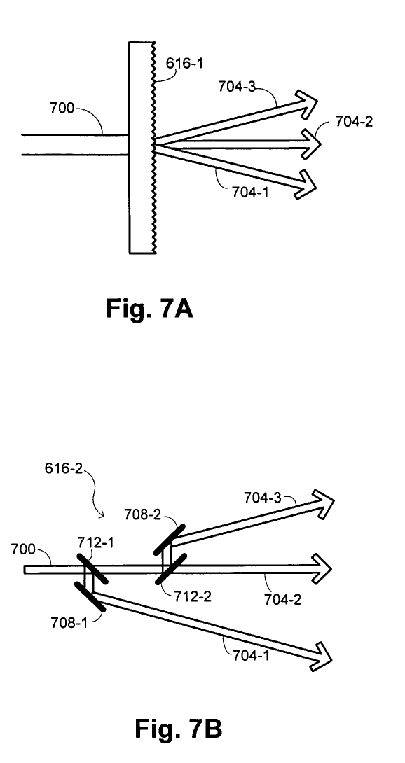

Still another embodiment is illustrated in FIG. 8, in which a conventional CD or DVD head is adapted to read information from the optical card. The overall arrangement of the internal structure of the optical card reader 308 is similar to that shown in FIG. 5, with a roller 832 being used to propel or regulate the speed of a card through a slot 804, which may correspond to an internal slot as described in connection with FIG. 4A or a swipe slot as described in connection with FIG. 4B. One or more light interruption switches 823 may be used to sense the presence of the card and to activate the optical reading mechanism, which is an adapted CD or DVD head as indicated by element 812. In same embodiments, the head 812 reads a single track of data per optical-card swipe, although in some embodiments the head 812 may comprise a plurality of heads to enable a plurality of tracks to be read per optical-card swipe.

Use of a CD or DVD head 812 generally involves some modification to the head 812 to accommodate differences in layouts on optical cards and on CDs or DVDs. A detailed description of how such a CD or DVD head may be modified is provided in U.S. patent application Ser. No. 10/921,596, which has been incorporated herein by reference. Table 1 summarizes a number of properties of an exemplary optical card with a compact disc.

TABLE 1
Summary of formats for optical cards and compact discs

| Quantity | Optical Card | Compact Disc |
|---|---|---|
| Track Pitch (μm) | 12.0 | 1.6 |
| Track Guide Width | 2.2 | 0.5 |
| (μm) | | |
| Pit Distance (μm) | 5 | 0.83 |
| Pit Diameter (μm) | 2.2 | ˜0.5 |
| Laser Wavelength (nm) | 760-850 | 780 |
| Area/bit (μm²) | 60 | 1.3 |
| Area (mm²) | 2070 | 8796 |
| Head Velocity | 100 mm/s | 1.2-1.4 m/s |
| Beam Diameter (μm) | 2.5 | |
| Recording Method | MFM-RZ | MFM |
| Bit Frequency | 10-20 kHz | 4.3 MHz |

In the table, the pit diameter for the compact disc has been estimated based on other physical parameters. Also, the head velocity has been determined from an angular speed of a compact disc of 200-600 rpm. The designation of the recording method as “MFM” for the compact disc refers to modified frequency modulation, which is well known in the art as a refinement of frequency-modulation encoding to reduce the number of flux reversals by inserting a clock reversal only between consecutive zeros. The designation “MFM-RZ” refers to a further modification of MFM encoding with a return to zero so that a flux reversal is used to indicate a “1” bit and the lack of a flux reversal is used to indicate a “0” bit.

The table notes that both certain optical cards and compact discs may be read with a laser wavelength of about 0.78 μm. One difference between the two formats is that the track guides for an optical card may be about 7.5 times larger than those for a compact disc; the pit diameter for the compact disc is also generally smaller than for an optical card because it needs to fit within the smaller 1.6-μm track. These differences preclude widely available compact-disc laser heads from simply being used to read data from optical cards. The inventor has recognized, however, that a modification in physical orientation of a compact-disc laser drive relative to a direction of motion for an optical card permits a compact-disc laser head to be used in a system for reading data from optical cards. In some embodiments, the compact-disc laser head is rotated by an additional angle relative to the direction of motion.

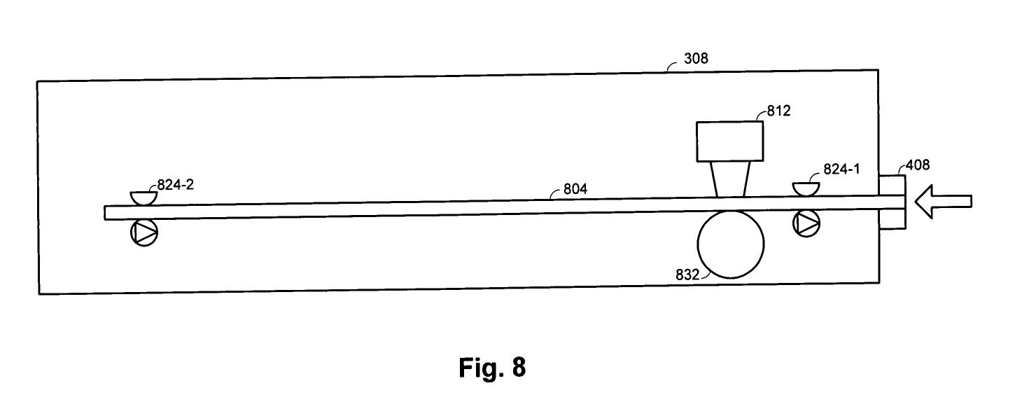

A schematic illustration of the structure of a typical compact-disc laser head is provided in FIG. 9A. The laser head 812 comprises a source of substantially monochromatic illumination, such as a diode laser 908. Light from the illumination source 908 is directed to a diffraction grating 916, which splits the light into a main beam and two secondary beams according to different diffraction orders. In particular, the angles α of the beams are given by the diffraction grating equation
d sin α=mλ
where d is the grating period and m is an integral order of interference for light having a wavelength λ. The zero-order beam (m=0) thus corresponds to the main beam for reading data and has no change in angle of propagation. The first-order beams (m=±1) correspond to the secondary beams and act as tracking beams deflected by angles ±α. Virtual images of the illumination source corresponding to these secondary beams are denoted by numerals 912. The beams pass through a beamsplitter 920 and are focused by a lens 932 onto the surface of the optical card 100, intended to be the surface of a compact disc in the conventional operation of a compact-disc laser head 812. Light reflected from the medium surface 100 is refocused by the lens 932 onto a detector array 924, such as a photodiode array. The presence or absence of pits on the surface medium at particular locations is determined by whether light is detected at the detector array 924.

For the simplified illustration shown, the medium moves in a direction substantially out of the page. A tracking motor (not shown) moves the head assembly 904 up and down and a focusing motor (not shown) moves the head assembly 904 in left/right directions. Double-headed arrows are labeled on the drawing to show the directions of motions provided by the respective motors. Also, for purposes of illustration, the optics shown in FIG. 9A have been somewhat simplified so that they may conveniently be illustrated in two dimensions. In many instances, actual compact-disc laser heads direct the beams in three dimensions but use the same principles illustrated in FIG. 9A. For instance, some compact-disc laser heads include a folding mirror at location 928 to point the beams downwards by 90°, causing the diffraction grating 916 and detector array 924 to be tipped about 45° out of the plane of the page. Still other modifications may be present in various compact-disc laser head designs, such as by using a prism or grism as a diffractive element in place of the grating 916 and/or by using curved mirrors in place of the lens 932.

A schematic illustration is provided for a typical layout of the detector array 924 in FIG. 9B. In this example, the detector array 924 comprises a plurality of photodiodes that detect light, with the photodiodes being labeled “A,” “B,” “C,” “D,” “E,” and “F.” The data are extracted from the central photodiodes as a sum of intensities on the central photodiodes, A+B+C+D. A focusing error may be determined by a difference in intensity for crossed configurations of the photodiodes, i.e. from (A+D)−(B+C). In similar fashion, a tracking error may be determined from a difference in intensity for the side photodiodes, i.e. from E−F. While the layout shown in FIG. 9B is common in compact-disc laser heads, it is possible in some instances for alternative arrangements to be used without deviating from the scope of the invention described herein.

The physical parameters for compact-disc laser heads are designed to accommodate the physical layout of data on compact discs. Such parameters include the optical properties of the optical components, such as focal length of the lens, the grating period of the diffraction grating, and the like, as well as the relative positioning of elements, such as distances between the light source and grating, distances between the grating and beam splitter, distances between the beam splitter and the lens, etc. These parameters are carefully determined by manufacturers of compact-disc laser heads to meet stringent performance criteria in reading optically encoded information at the level of microns. The inventor has realized, however, that even with the resulting structure of a compact-disc laser head being specifically tailored to reading compact discs, it may be used in a system for reading optical data from optical cards. This may be accomplished without modification to the internal structure of the compact-disc laser head by orienting the laser head relative to a direction of motion of the optical card with respect to the laser head to accommodate a difference between an average optical-card track pitch and an average compact-disc track pitch for which the laser head is designed.

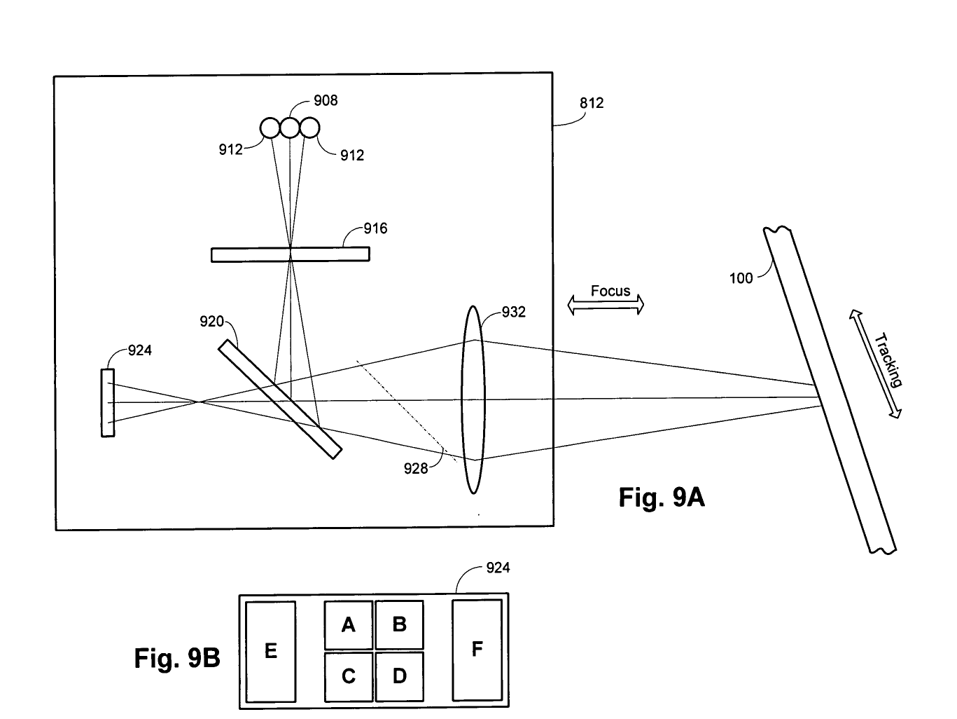

An overview of how the relative orientation of a given compact-disc laser head may be determined is provided with the flow diagram of FIG. 10. Characteristics that define how the physical data layout for which the compact-disc laser head was designed are determined at blocks 1004 and 1008. In particular, the track pitch and tracking beam separation for which the compact-disc laser head was designed are determined. From this information, an orientation θ is determined at block 1012 for the tracking beam provided by the laser head relative to the direction of motion of the compact disc with respect to the laser head. For example, for a determined compact-disc track pitch p_{CD} and determined tracking-beam separation s, the desired orientation may be

$$θ = {tan}^{- 1} \frac{{p}_{CD}}{s} .$$

It should be appreciated that references herein to relative motion of an optical medium, such as a compact disc or a optical card, with respect to the laser head may be provided by movement of the optical medium, by movement of the laser, or by movement of both in different embodiments. All such possibilities are intended to be included within the scope of references to motion of an optical medium relative to a laser head.

At block 1016 of FIG. 10, the desired orientation 0′ of the tracking beam to accommodate the track pitch of an optical card is determined. For example, to accommodate an optical-card track pitch pₒ, the desired orientation may be

$${θ}^{′} = {tan}^{- 1} \frac{{p}_{o}}{s} ,$$

where the same tracking-beam separation has been used. It was not initially apparent that the tracking-beam separations for the two instances would be sufficiently similar that a determination of θ′ could be made in this way, i.e. that a suitable orientation to accommodate the compact-disc track pitch would allow the tracking beam arrangement of the compact-disc laser head to function correctly. The explicit example described below illustrates an analysis undertaken by the inventor to confirm that the tracking-beam arrangement would, in fact, function correctly with the desired orientation. As indicated at block 1020, the difference in angles, Δθ=θ′−θ, then defines an additional rotation of the compact-disc laser head to be used in a system for reading optical cards.

To illustrate how a CD or DVD laser-head unit may be adapted for reading an optical card, a specific example was discussed in detail in U.S. patent application Ser. No. 10/921,596, which has been incorporated herein by reference.

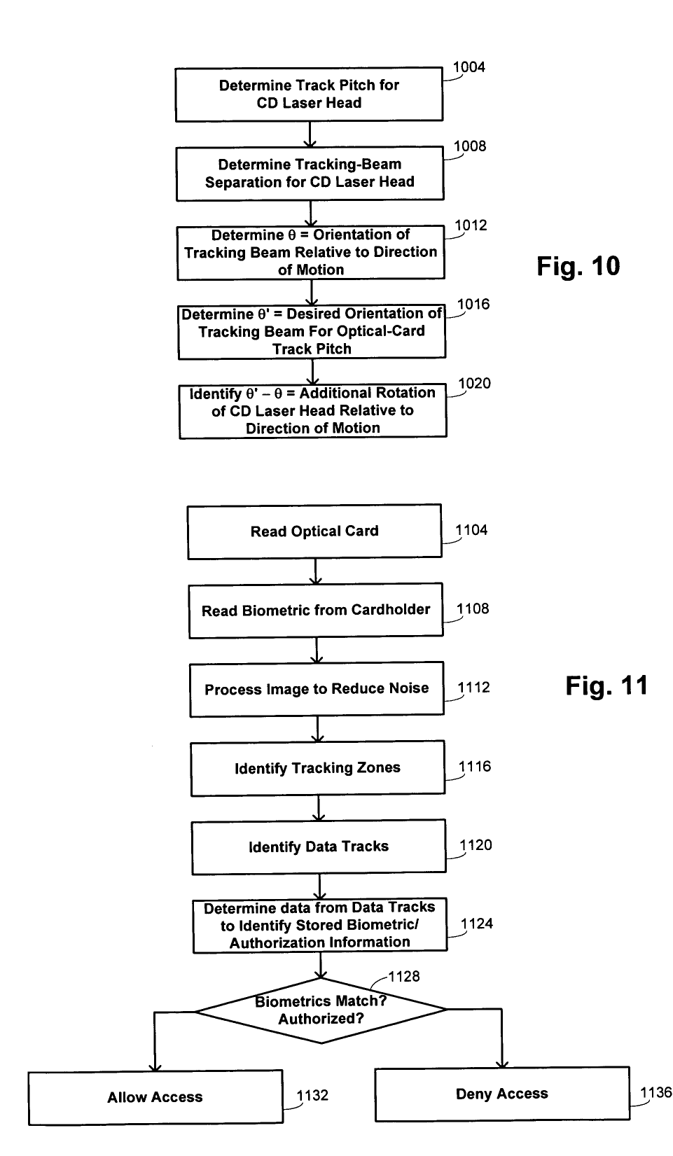

Irrespective of which embodiment is used for the structure of the optical card reader, similar methods may be used in analyzing the data that are read to implement the authentication and authorization functions of the invention. One method according to an embodiment of the invention is summarized with the flow diagram of FIG. 11. The depicted portion of the method begins at block 1104 after the cardholder 304 has presented the optical card to the optical card reader 308. The optical card is read at block 1104 using structure like that described above for different embodiments. At block 1108, a biometric is also read from the cardholder 308, such as after the cardholder places his finger on a fingerprint reader or provides some other body part for measurement.

Before comparing the measured biometric with the biometric information read from the card 100, image-processing algorithms may be implemented at block 1112, including algorithms to reduce noise. The tracking and data zones may be identified respectively at blocks 1116 and 1120 using such techniques as edge-detection and blob-growing algorithms, although other techniques may be used in alternative embodiments as known to those of skill in the art. The biometric, and perhaps also authorization information, is resolved after such preprocessing at block 1124, permitting the comparison to be performed at block 1128.

If it is determined that the biometrics match, usually in the sense that differences between the measured biometric and the biometric read from card differ less than an amount consistent with an acceptable confidence level, access to the restricted area or function is allowed at block 1132 This may comprise deactivating a door lock in cases where access to a secured area is being controlled and may comprise changing a state of an indicator light 412 on the optical card reader 308 or causing an audible sound to be generated. If there is no match between the biometrics, access is denied at block 1136, which may be coupled with a visual or audible indicator of the denial such as by causing a state of an indicator light 412 on the optical card reader 308. In some instances, the failed authentication or authorization may be reported to a security system coupled with the wide-area network 340.

While FIG. 11 and the description above have focused on the comparison of biometric information to allow or deny access, such biometric comparison may be considered to be a specific example of a more general class of comparisons that may be performed between a token read from optical card and compared with a token provided by the person presenting the optical card. For instance, in some embodiments the token might comprise a PIN or a hash of a PIN. In still other embodiments, the mere presence of an authenticating token on the optical card may be sufficient to allow access, even without a comparison being performed with a token provided by an individual.

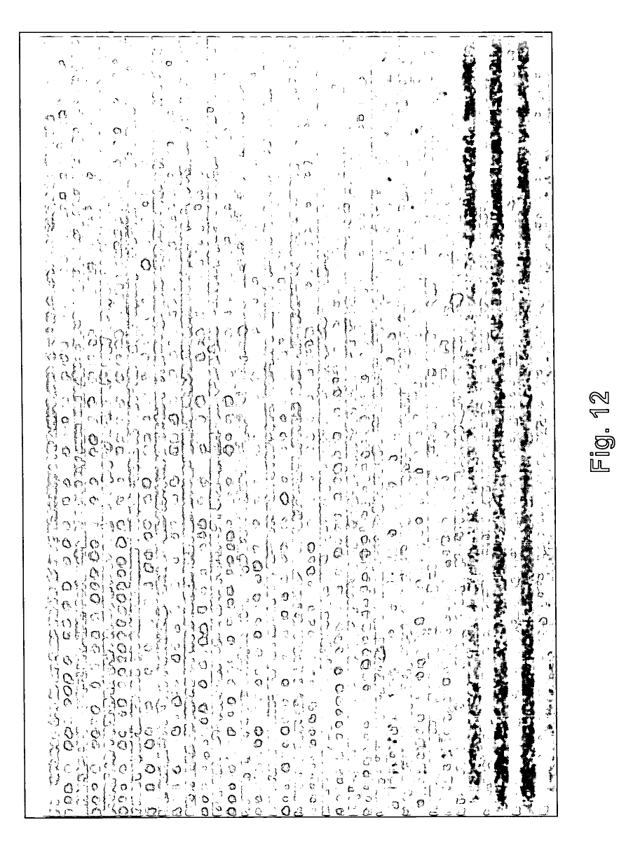

FIG. 12 illustrates the types of images that may be collected with a CCD array and illustrates the structure of data as encoded on an optical card. This drawing provides an image of a portion of an optical storage area 112 that was collected with a two-dimensional CCD array. This image is not intended to illustrate the structure of the logical tracks encoded with blobs used in some embodiments of the invention, but is intended more generally to illustrate the structure of encoded data and to illustrate the imaging capabilities of a CCD array.

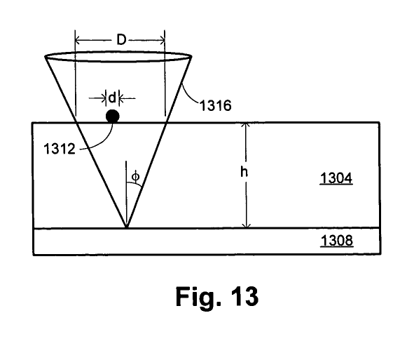

The arrangements of FIGS. 6 and 8 may provide substantially different numerical apertures φ, which results in different imaging characteristics. For example, while φ of the CD or DVD head 812 in FIG. 8 might be on the order of 0.5, φ for the apparatus shown in FIG. 5 might be 5 or 10 times smaller, i.e. on the order of 0.05-0.1. Such a difference in numerical aperture affects the blur diameter of the optical card being imaged, and this difference may be accommodated is same embodiments that use the arrangement of FIG. 8 by providing a protective layer on the optical card 100. An illustration of a side view of an optical card is provided in FIG. 13, with the pit-carrying layer 1308 covered by a thickness h of a protective layer. The protective layer is optically clear at wavelengths used to read the optical card and has no contaminations in its volume. Instead a contaminant 1312 might reside on the surface of the protective layer. The illustration shows that the presence of a contaminant in this position may still affect the ability to read the data from the pit-carrying layer 1308 by overlapping part of an incident read beam 1316. The thickness of the contaminant 1312 and of the read beam 1316 at the surface of the protective layer 1304 are respectively denoted d and D.

The blur diameter for constant d is approximately proportional to φ²/h. The inventors have thus found that there are several effects that may improve the reliability of reading data from the pit-carrying layer, both of which are illustrated with the geometry shown in FIG. 13. First, the thickness h of the protective layer may be increased, thereby decreasing the relative size d/D. Second, the numerical aperture φ of the read beam may be increased, thereby also decreasing the relative side d/D. Perhaps even more significantly, the increase in +causes the blur diameter to be larger so that the overall effect of dirt on the optical card 100 is effectively “washed out” by the optical system. In some exemplary embodiments, the head 812 may thus be 25-100 times less susceptible to interference by a given piece of dirt at a given height from the data of interest. Each of these effects may be implemented separately or in combination in different embodiments to improve the read reliability from the optical card 100.

Conversely, embodiments of the invention that use a structure such as shown in FIG. 6 may be provided without a focusing system for the same reason. Because such a system may be provided with a substantially smaller numerical aperture, the blur diameter of the data may be smaller as the optical card 100 is swiped and the distance to the lens changes as a result of the swiping action.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A read-only optical device comprising:
a housing having a slot for slidably receiving an optical card, the optical card having a plurality of physical tracks with an arrangement of physical pits to define an optically encoded biometric;
a light detector fixed in position relative to the housing;
an optical train fixed in position relative to the housing and configured to provide optical paths between the light detector and the optical card as the optical card is slid along the slot;
a biometric sensor; and
a processor coupled with the light detector and with the biometric sensor, the processor having programming instructions to compare a biometric measured by the biometric sensor with the optically encoded biometric read from the optical card with the light detector.

2. The read-only optical device recited in claim 1 further comprising a security actuator coupled with the processor, the processor further comprising programming instructions to activate the security actuator to permit access to a controlled area or function if the measured biometric substantially matches the optically encoded biometric read from the optical card.

3. The read-only optical device recited in claim 1 wherein the biometric sensor comprises a fingerprint sensor.

4. The read-only optical device recited in claim 1 further comprising a first light interruption switch disposed to identify the presence of the optical card within the slot.

5. The read-only optical device recited in claim 4 further comprising a second light interruption switch.

6. The read-only optical device recited in claim 1 wherein:
the optical card comprises a plurality of logical tracks disposed transversely across the optical card, each such logical track comprising a plurality of the physical tracks; and
the optical train comprises a fanout element to provide distinct optical paths between the light detector and transverse portions of the optical card corresponding to different ones of the logical tracks.

7. The read-only optical device recited in claim 6 wherein the optical train further comprises:
a collimation element;
a partially reflective mirror; and
a focusing element,
wherein:
the light detector comprises a multielement light sensor;
the collimation element is disposed to collimate light incident on the fanout element;
the partially reflective mirror is disposed to reflect light emanating from the fanout element to the focusing element and to permit light reflected from the optical card to propagate to the light detector; and
the focusing element is disposed to focus light reflected from the partially reflective mirror onto the optical card.

8. The read-only optical device recited in claim 6 wherein the fanout element comprises:
first and second partially reflective mirrors, wherein:
a beam incident on the first partially reflective mirror is partially reflected to provide a first beam and is partially transmitted to provide an intermediate beam incident on the second partially reflective mirror; and
the intermediate beam is partially reflected from the second partially reflective mirror to provide a second beam and is partially transmitted by the second partially reflective mirror to provide a third beam.

9. The read-only optical device recited in claim 1 wherein the light detector comprises a multielement array sensor.

10. The read-only optical device recited in claim 1 wherein the light detector comprises a compact-disc laser head adapted to read data from a compact disc having data encoded as a series of binary pits formed within a plurality of compact-disc tracks separated by an average compact-disc track pitch, the compact-disc laser head being oriented relative to a length of the slot to accommodate a difference between an average optical-card track pitch separating the plurality of physical tracks and the average compact-disc track pitch.

11. A method of controlling access to a restricted area or function, the method comprising:
detecting a presence of an optical card being moved manually by a human being, the optical card having a plurality of physical tracks with an arrangement of physical pits to define an optically encoded token;
illuminating a fixed region through which a surface of the optical card passes as the optical card is moved manually by the human being;
propagating light reflected from the optical card as the optical card is moved manually by the human being to a fixed light detector to read the optically encoded token;
receiving a reference token from the human being; and
comparing the reference token received from the human being with the optically encoded token read from the optical card.

12. The method recited in claim 11 wherein:
the optically encoded token comprises an optically encoded biometric;
receiving the reference token from the human being comprises measuring a biometric from the human being; and
comparing the reference token received from the human being with the optically encoded token read from the optical card comprises comparing the biometric measured from the human being with the optically encoded biometric read from the card.

13. The method recited in claim 12 further comprising actuating a security actuator to permit access to the restricted area or function if the biometric measured from the human being substantially matches the optically encoded biometric read from the optical card.

14. The method recited in claim 12 wherein measuring the biometric from the human being comprises measuring a fingerprint from the human being.

15. The method recited in claim 12 wherein:
the optical card comprises a plurality of logical tracks disposed transversely across the optical card, each such logical track comprising a plurality of the physical tracks;
propagating light reflected from the optical card as the optical card is moved manually by the human being to the fixed light detector comprises propagating light reflected from different ones of the logical tracks along distinct optical paths to the fixed light detector.

16. An optical card comprising a substrate having a plurality of physical pits formed within a plurality of physical tracks organized as a series of substantially parallel rows within the substrate, wherein:
the physical pits define a pattern of blobs within a plurality of logical tracks, each such logical track spanning a plurality of the physical tracks; and
the pattern of blobs is an encoded arrangement of data.

17. The optical card recited in claim 16 wherein the encoded arrangement of data comprises an encoded biometric.

18. The optical card recited in claim 16 wherein the plurality of logical tracks consists of three tracks.

19. The optical card recited in claim 18 wherein the one of the three tracks comprises a timing track.

20. The optical card recited in claim 19 wherein the timing track is a center one of the three tracks and comprises a logical blob sequence of alternating binary states.

21. The optical card recited in claim 15 further comprising an optically transparent protective layer overlaying the substrate.

22. The optical card recited in claim 21 wherein the optically transparent protective layer has a thickness at least five times a thickness of the substrate.

23. A method for reading an optical card having a plurality of physical pits formed within a plurality of physical tracks organized as a series of substantially parallel rows within the substrate, the method comprising:
illuminating each of a plurality of logical tracks, each such logical track spanning a plurality of the physical tracks;
receiving light reflected from the plurality of logical tracks to identify a pattern of blobs within the plurality of logical tracks, each such blob comprising a two-dimensional array of physical pits; and
decoding the pattern of blobs to identify an encoded arrangement of data.

24. The method recited in claim 23 wherein the encoded arrangement of data comprises an encoded biometric.

25. The method recited in claim 23 wherein the plurality of logical tracks consists of three tracks.
